(19) United States
(12) Patent Application Publication
(10) Pub. No.: US 2007/0193393 A1
(43) Pub. Date: Aug. 23, 2007

(54) Push rod bracket assembly for use with a brake pedal assembly and method of assembly thereto

(76) Inventor: Allen R. Collins, Ortonville, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/341,547

(22) Filed: Jan. 27, 2006

(51) Int. Cl. G05G 1/14

(52) U.S. Cl. 74/512

(57) ABSTRACT

The invention concerns a push rod bracket assembly for use with a brake pedal assembly and method of assembly thereto. A pedal attachment pin is fixed to a brake pedal arm, and a booster clevis is mounted to the pin. The booster clevis may have a retainer clevis leg that mounts around the pin on one side of the arm and a slotted clevis leg with a slot that slides over the pin on the other side of the arm. A wave washer may be mounted in compression between the arm and slotted clevis leg to bias the leg, and a retainer clip may be mounted on the pin to secure the retainer clevis leg on the pin.

### BACKGROUND OF INVENTION

The present invention relates generally to an assembly connecting a pedal to a component, and in particular to an assembly for engaging a brake booster to a brake pedal in a vehicle and method of assembly.

Brake pedal assemblies employed in automotive vehicles typically have a pivot location near the top of a brake pedal arm, a brake pedal at the bottom of the arm, and an assembly near the middle of the arm for connecting a brake booster push rod to the brake pedal arm while allowing some pivoting motion between the two. Such assemblies may include, for example, a push rod having an eyelet on one end that is secured around a pin extending from the brake pedal arm, with a cotter pin or other type of retainer clip mounted on the pin to prevent the eyelet from slipping off. In another example, the assembly includes a clevis having arms that mount on either side of the brake pedal arm, with a pin that is slid through holes in the clevis and arm after the clevis is properly located on the arm. A cotter pin or other type of retainer clip is employed to prevent the pin from sliding back out of the holes. However, if the cotter pin or retainer is missing, due to breakage or other means, a potential exists for the connection between the brake pedal arm and booster push rod to be less than secure.

Other attachment methods overcome this concern by, for example, the use of multiple piece booster input rods, or by employing redundant (secondary) retention means. These methods, however, may be more costly or complicated than is desirable.

It is desirable, therefore, to provide a means for attaching a booster push rod to a brake pedal arm that does not rely solely on a cotter pin or retainer member to assure secure attachment of the two, while also minimizing the cost and complexity for the attachment means.

### SUMMARY OF INVENTION

An embodiment of the present invention may contemplate a push rod bracket assembly for linking a brake pedal assembly, having a brake pedal arm, to a booster assembly. The push rod bracket assembly may comprise a booster clevis including a push rod support wall having a booster push rod extending therefrom and adapted to engage the booster assembly, a retainer clevis leg extending from the push rod support wall, and a slotted clevis leg extending from the push rod support wall and spaced from the retainer clevis leg. The slotted clevis leg may include a pin slot with a slot opening and an outer surface and be adapted to mount on a first side of the brake pedal arm. The retainer clevis leg includes a pin hole therethrough and is adapted to mount on an opposed second side of the brake pedal arm. Also, the push rod bracket assembly may comprise a pedal attachment pin having a pedal arm attachment portion adapted to be fixed to the brake pedal arm, a retainer portion extending from the brake pedal arm attachment portion and through the pin hole in the retainer clevis leg, a spacer portion extending from the brake pedal arm attachment portion and through the pin slot, and a retention head pin portion extending from the spacer portion and engaging with the outer surface of the slotted clevis leg.

An embodiment according to the present invention may contemplate a brake pedal and bracket assembly for engaging a booster assembly. The brake pedal and bracket assembly may comprise a brake pedal arm having a first side and an opposed second side, and a bracket attachment hole extending from the first side to the second side, a booster clevis, pedal attachment pin and biaser. The booster clevis may include a push rod support wall having a booster push rod extending therefrom and adapted to engage the booster assembly, a first clevis leg extending from the push rod support wall and mounted adjacent to the first side, and a second clevis leg extending from the push rod support wall and mounted adjacent to the second side, the first and second clevis legs each including a bore aligned with the bracket attachment hole. The pedal attachment pin may be fixed to the brake pedal arm and have a pedal arm attachment portion extending through the bracket attachment hole, a spacer portion extending from the brake pedal arm attachment portion and through the bore in the first clevis leg, and a retention head portion extending from the spacer portion and engaging with the first clevis leg. The biaser may be mounted between the first side of the brake pedal arm and the first clevis leg, and bias the first clevis leg away from the first side.

An embodiment according to the present invention may contemplate a method of assembling a push rod bracket assembly to a brake pedal assembly, the method comprising the steps of: inserting a pedal attachment pin through a bracket attachment hole in a brake pedal arm; fixing the pedal attachment pin to the brake pedal arm; mounting a biaser adjacent to the pedal attachment pin on a first side of the brake pedal arm; mounting a pin hole of a retainer clevis leg about the pedal attachment pin adjacent to an opposed second side of the brake pedal arm; and sliding a pin slot of a slotted clevis leg onto the pedal attachment pin between the biaser and a retention head portion of the pedal attachment pin such that the biaser is compressed between the first side of the brake pedal arm and the slotted clevis leg.

An advantage of an embodiment of the present invention is that the attachment of the booster push rod to the brake pedal arm remains secure, even in the event of a missing or broken retainer clip.

Another advantage of an embodiment of the present invention is that the secure connection between the booster push rod and brake pedal arm is relatively cost-effective and easy to assemble.

### BRIEF DESCRIPTION OF DRAWINGS

FIG. 1 is a perspective view of a portion of a brake pedal assembly, in accordance with the present invention.

FIG. 2 is a perspective view of an upper portion of the brake pedal assembly of FIG. 1.

FIG. 3 is a perspective view, on an enlarged scale, of a portion of the brake pedal assembly of FIG. 1, showing the slotted side of the push rod bracket assembly.

FIG. 4 is a perspective view, on an enlarged scale, of a portion of the brake pedal assembly of FIG. 1, showing the retainer clip side of the push rod bracket assembly.

FIG. 5 is a schematic, cross section view of the push rod bracket assembly attachment to a brake pedal arm, in accordance with the present invention.

FIG. 6 is a schematic, perspective view, of a booster clevis and booster assembly, in accordance with the present invention.

### DETAILED DESCRIPTION

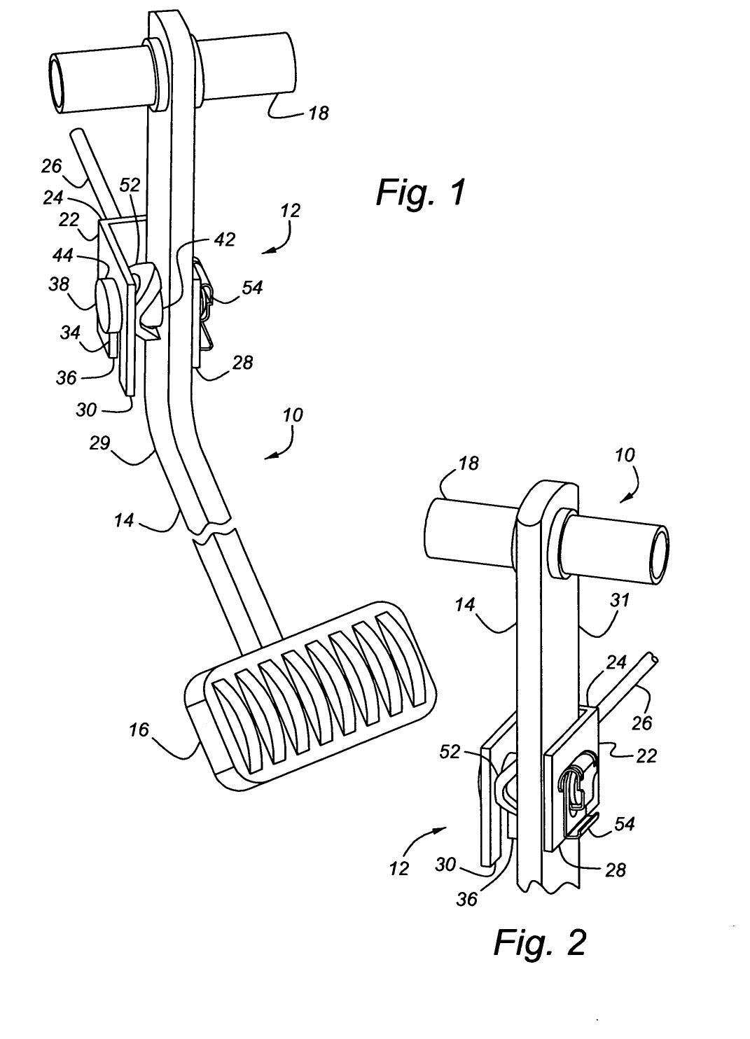

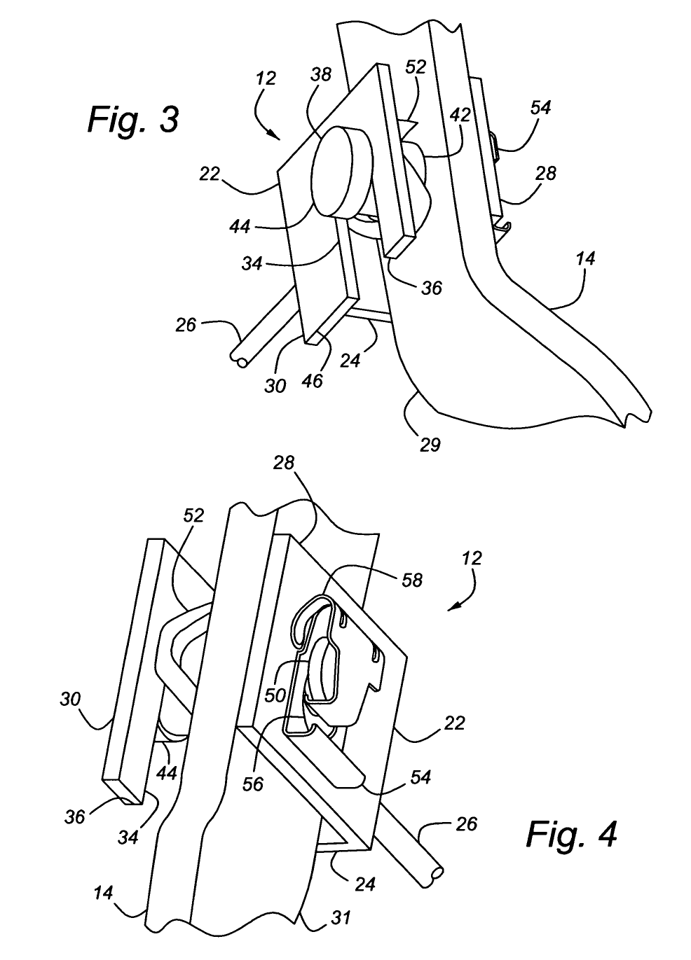

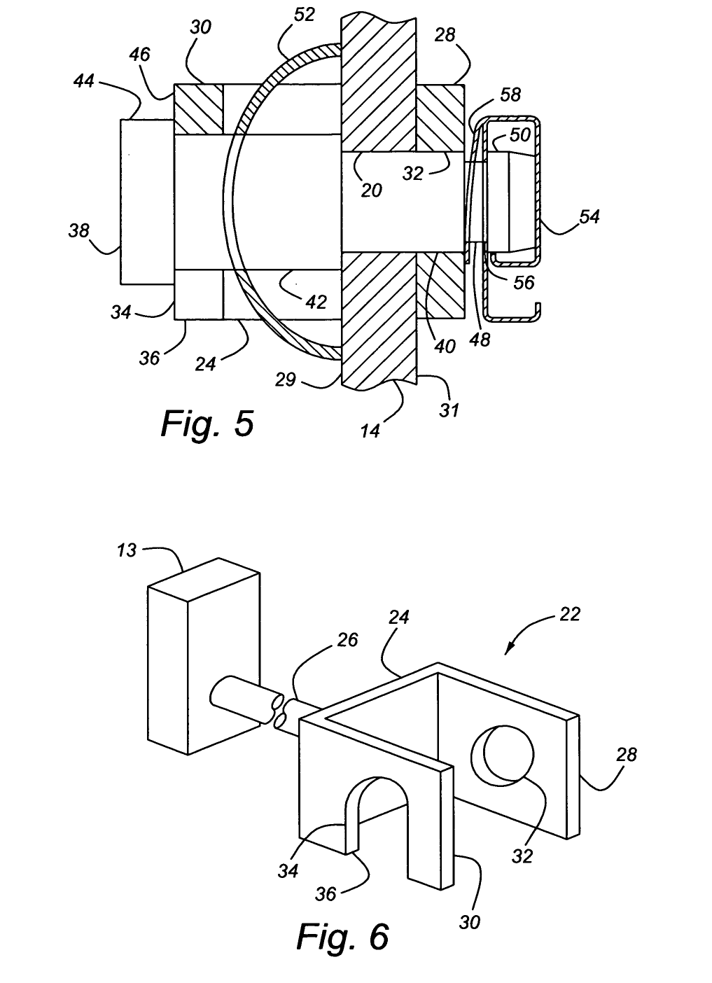

FIGS. 1-6 illustrate a brake pedal assembly, indicated generally at 10, connected to a push rod bracket assembly, indicated generally at 12. The push rod bracket assembly 12 also engages a booster assembly 13 (indicated schematically in FIG. 6). The booster assembly 13 is known to those skilled in the art and so will not be discussed or shown in any more detail herein.

The brake pedal assembly 10 includes a brake pedal arm 14, with a brake pedal 16 at a lower end and an upper pivot shaft 18 near an upper end. The brake pedal assembly 10 also includes a bracket attachment hole 20 through the brake pedal arm 14, through which the brake pedal assembly 10 engages the push rod bracket assembly 12.

The push rod bracket assembly 12 includes a booster clevis 22 having a pushrod support wall 24, with a booster push rod 26 extending outward therefrom into engagement with the booster assembly 13. Extending away from the pushrod support wall 24 are two spaced apart legs—a retainer clevis leg 28 and a slotted clevis leg 30. The retainer clevis leg 28 mounts on a first side 29 of the brake pedal arm 14 and includes a pin hole 32 that aligns with the bracket attachment hole 20. The slotted clevis leg 30 is spaced from an opposed second side 31 of the brake pedal arm 14 and includes a pin slot 34 that aligns with the bracket attachment hole 20 at the upper end of the pin slot 34 and includes a slot opening 36 through the bottom of the slotted clevis leg 30.

A pedal attachment pin 38 includes a pedal arm attachment portion 40 that is mounted and secured in the bracket attachment hole 20 in the brake pedal arm 14. The method used for securing the pedal attachment pin 38 to the pedal arm 14 can be accomplished through various means, such as, for example, various types of peening operations, orbital riveting, staking, or other suitable methods. The pedal attachment pin 38 is fixed to the brake pedal arm 14 in order to assure that the attachment pin 38 will not slip out of the bracket attachment hole 20—even if a retainer clip (discussed below) is missing or broken. The pedal arm attachment portion 40 extends outward beyond the bracket attachment hole 20 in the brake pedal arm 14 through the pin hole 32 in the retainer clevis leg 28. A smaller diameter retainer neck portion 48 extends from the pedal arm attachment portion 40, and a retainer portion 50—having a larger diameter than the retainer neck portion 48—extends from the retainer neck portion 48.

The pedal attachment pin 38 also includes a spacer shaft portion 42 adjacent to the pedal arm attachment portion 40. This spacer shaft portion 42 extends outward from the brake pedal arm 14 into engagement with the pin slot 34 in the slotted clevis leg 30. A retention head portion 44 of the pedal attachment pin 38 is adjacent to the spacer shaft portion 42 and has a diameter that is larger than the opening of the pin slot 34 in order to engage an outer surface 46 of the slotted clevis leg 30 around the pin slot 34.

A wave washer 52 is mounted about the spacer shaft portion 42 between the brake pedal arm 14 and the slotted clevis leg 30. The wave washer 52 biases the slotted clevis leg 30 away from the brake pedal arm 14, which causes the retainer clevis leg 28 to be biased against the brake pedal arm 14. While a wave washer 52 is illustrated in this embodiment, other types of mechanisms for biasing the retainer clevis leg 28 away from the brake pedal arm 14 may be employed instead if so desired.

A retainer clip 54 mounts over the retainer portion 50 and engages the retainer neck portion 48 of the pedal attachment pin 38. A retention slot 56 slides over the retainer neck portion 48 but has an opening small enough that it seats against and is retained by the retainer portion 50. Spring tabs 58 help assure that the retainer clip 54 stays secure on the pedal attachment pin 38. While a retainer clip 54 is illustrated in this embodiment, other types of mechanisms for preventing the retainer clevis leg 28 from sliding off the end of the pedal attachment pin 38 may be employed instead if so desired. For example, a cotter pin type of arrangement may be employed.

An installation process for assembling the push rod bracket assembly 12 to the brake pedal assembly 10 will now be described. The pedal attachment pin 38 is installed in the bracket attachment hole 20 of the brake pedal arm 14 and fixed in place by a securing method, such as those discussed above. The wave washer 52 is installed around the spacer shaft portion 42 of the pedal attachment pin 38. Then, the pin hole 32 of the retainer clevis leg 28 is slid over the retainer portion 50 and onto the pedal arm attachment portion 40 of the pedal attachment pin 38 as the slot opening 36 of the slotted clevis leg 30 is slid over the spacer shaft portion 42 between the wave washer 52 and the retention head portion 44. The retainer clip 54 is then secured to the retainer neck portion 48 and around the retainer portion 50 of the pedal attachment pin 38.

One will note that the slot opening 36 allows the booster clevis 22 to be assembled to the pedal attachment pin 38 with ease even though the pedal attachment pin 38 is already fixed to the brake pedal arm 14. The pedal attachment pin 38 being fixed to the brake pedal arm 14 is advantageous because the wave washer 52 will cause the retainer clevis leg 28 to be biased against the brake pedal arm 14 without the pedal attachment pin 38 pulling out of the bracket attachment hole 20. Consequently, should the retainer clip 54 be inadvertently left off the assembly or break, the retainer clevis leg 28 will remain securely against the brake pedal arm 14 rather than slipping off the end of the pedal attachment pin 38. The booster clevis 22 will remain securely on the pedal attachment pin 38 and in the proper position for the brake pedal assembly 10, allowing the booster push rod 26 to properly engage the booster assembly 13.

While certain embodiments of the present invention have been described in detail, those familiar with the art to which this invention relates will recognize various alternative designs and embodiments for practicing the invention as defined by the following claims.

What is claimed is:

1. A push rod bracket assembly for linking a brake pedal assembly, having a brake pedal arm, to a booster assembly, the push rod bracket assembly comprising:
a booster clevis including a push rod support wall having a booster push rod extending therefrom and adapted to engage the booster assembly, a retainer clevis leg extending from the push rod support wall, and a slotted clevis leg extending from the push rod support wall and spaced from the retainer clevis leg, the slotted clevis leg including a pin slot with a slot opening and an outer surface and being adapted to mount on a first side of the brake pedal arm, and the retainer clevis leg including a pin hole therethrough and being adapted to mount on an opposed second side of the brake pedal arm; and
a pedal attachment pin having a pedal arm attachment portion adapted to be fixed to the brake pedal arm, a retainer portion extending from the brake pedal arm attachment portion and through the pin hole in the retainer clevis leg, a spacer portion extending from the brake pedal arm attachment portion and through the pin slot, and a retention head pin portion extending from the spacer portion and engaging with the outer surface of the slotted clevis leg.

2. The push rod bracket assembly of claim 1 further comprising a retainer clip mounted on the retainer portion and blocking the retainer clevis leg from sliding off of the pedal attachment pin.

3. The push rod bracket assembly of claim 2 further comprising a wave washer mounted about the spacer portion adjacent to the slotted clevis leg and adapted to engage the first side of the brake pedal arm to bias the slotted clevis leg away from the brake pedal arm.

4. The push rod bracket assembly of claim 2 wherein the retainer clip includes spring tabs extending therefrom adapted to bias the retainer clevis against the second side of the brake pedal arm.

5. The push rod bracket assembly of claim 1 further comprising a wave washer mounted about the spacer portion adjacent to the slotted clevis leg and adapted to engage the first side of the brake pedal arm to bias the slotted clevis leg away from the brake pedal arm.

6. The push rod bracket assembly of claim 1 wherein the pedal attachment pin is adapted to be fixed to the brake pedal arm by one of a peening, orbital riveting, or staking operation.

7. A brake pedal and bracket assembly for engaging a booster assembly, the brake pedal and bracket assembly comprising:
a brake pedal arm having a first side and an opposed second side, and a bracket attachment hole extending from the first side to the second side;
a booster clevis including a push rod support wall having a booster push rod extending therefrom and adapted to engage the booster assembly, a first clevis leg extending from the push rod support wall and mounted adjacent to the first side, and a second clevis leg extending from the push rod support wall and adjacent to the second side, the first and second clevis legs each including a bore aligned with the bracket attachment hole;
a pedal attachment pin, fixed to the brake pedal arm, having a pedal arm attachment portion extending through the bracket attachment hole, a spacer portion extending from the brake pedal arm attachment portion and through the bore in the first clevis leg, and a retention head portion extending from the spacer portion and engaging with the first clevis leg; and
a biaser mounted between the first side of the brake pedal arm and the first clevis leg, and biasing the first clevis leg away from the first side.

8. The brake pedal and bracket assembly of claim 7 wherein the biaser is a wave washer mounted around the spacer portion of the pedal attachment pin.

9. The brake pedal and bracket assembly of claim 8 wherein the bore in the first clevis leg is a slot that includes a slot opening slidable around the spacer portion of the pedal attachment pin.

10. The brake pedal and bracket assembly of claim 9 wherein the pedal attachment pin includes a retainer portion extending from the brake pedal arm attachment portion and through the bore in the second clevis leg, and wherein a retainer clip is mounted on the retainer portion and blocks the second retainer leg from sliding off of the pedal attachment pin.

11. The brake pedal and bracket assembly of claim 7 wherein the pedal attachment pin includes a retainer portion extending from the brake pedal arm attachment portion and through the bore in the second clevis leg, and wherein a retainer clip is mounted on the retainer portion and blocks the second retainer leg from sliding off of the pedal attachment pin.

12. The brake pedal and bracket assembly of claim 7 wherein the bore in the first clevis leg is a slot that includes a slot opening slidable around the spacer portion of the pedal attachment pin.

13. The brake pedal and bracket assembly of claim 7 wherein the pedal attachment pin is fixed to the brake pedal arm by one of a peening, orbital riveting, or staking operation.

14. A method of assembling a push rod bracket assembly to a brake pedal assembly, the method comprising the steps of:
inserting a pedal attachment pin through a bracket attachment hole in a brake pedal arm;
fixing the pedal attachment pin to the brake pedal arm;
mounting a biaser adjacent to the pedal attachment pin on a first side of the brake pedal arm;
mounting a pin hole of a retainer clevis leg about the pedal attachment pin adjacent to an opposed second side of the brake pedal arm; and
sliding a pin slot of a slotted clevis leg onto the pedal attachment pin between the biaser and a retention head portion of the pedal attachment pin such that the biaser is compressed between the first side of the brake pedal arm and the slotted clevis leg.

15. The method of claim 14 further comprising the step of mounting a retainer clip on the pedal attachment pin adjacent to the retainer clevis leg such that the retainer clevis leg is located between the retainer clip and the second side of the brake pedal arm.

16. The method of claim 15 wherein the biaser is a wave washer.

17. The method of claim 14 wherein the biaser is a wave washer.

18. The method of claim 14 wherein the step of fixing the pedal attachment pin to the brake pedal arm is further defined by performing a peening operation.

19. The method of claim 14 wherein the step of fixing the pedal attachment pin to the brake pedal arm is further defined by performing an orbital riveting operation.

20. The method of claim 14 wherein the step of fixing the pedal attachment pin to the brake pedal arm is further defined by performing a staking operation.
